(19) United States
(12) Patent Application Publication
(10) Pub. No.: US 2016/0146655 A1
(43) Pub. Date: May 26, 2016

(54) MONITORING DEVICE FOR GASEOUS FUEL

(71) Applicant: James Lee GARDINER, Brisbane (AU)

(72) Inventor: James Lee GARDINER, Brisbane (AU)

(21) Appl. No.: 14/784,907

(22) PCT Filed: Apr. 17, 2014
(86) PCT No.: PCT/AU2014/000443

§ 371 Date: Oct. 15, 2015

(30) Foreign Application Priority Data
Apr. 18, 2013 (AU) 2013901357
Aug. 22, 2013 (AU) 2013903184

(51) Int. Cl. G01F 23/02

(52) U.S. Cl. CPC G01F 23/02

(57) ABSTRACT

Provided is a monitoring device (1) for gaseous fuel. The device comprises a body (2) formed with a reservoir (45) covered with an observation window (68), an inflow passage (86) extending from an inlet port (3) into the reservoir, and an outflow passage (58) extending from an outflow port (4) to the reservoir. The inlet port is for connection to a gaseous fuel source and the out let port is for connection to gas conveying means (214) for supplying gaseous fuel from the network or container (s) to one or more gas appliances. The reservoir is partially filled with a mixture of a liquid which remains in liquid state between at least from −5° to 50° Celsius and a surfactant capable of breaking down oily substance. The liquid mixture is filled to a level above the inner end of the inflow passage. One or more baffle members (61) are provided in the reservoir at a position above the liquid mixture and the baffle member extends across the outflow passage.

### TECHNICAL FIELD

THIS INVENTION relates to a monitoring device for gaseous fuel being conveyed from a source to one or more gas appliances.

### BACKGROUND

Gas fuels are preferred by many people due to their relatively more efficient combustion properties and are considered to be more environmentally friendly when compared to coal fired energy sources. Gaseous fuel appliances are mostly used for cooking and heating in domestic and commercial sites. Typically, the appliances include gas water heaters, gas stoves, cook tops and ovens, and room heaters. They can also be used for lighting for illumination purposes. In industry sectors, gas apparatuses in the form of furnaces and turbines are gaining popularity. As used hereinafter the word “appliance” is intended to include any gas consuming apparatus or system. Gaseous fuels such as natural gas and liquefied petroleum gas (LPG) are used as the energy source for these appliances and apparatuses.

In regions where reticulated gaseous fuel is not available, the gaseous fuel is contained in one or more storage tanks as liquid under pressure and the storage container(s) are delivered to sites where the fuel is to be consumed. These storage tanks are commonly referred to as gas bottles or cylinders. The fuel exits the container(s) as gas. Gas conveying means such as pipe work is used for transferring the fuel from the storage tank(s) to one or more gas appliances on this site. A shut off valve is provided on each tank. In use, the valve on each tank must be connected to the conveying means and placed in the open position.

Government regulations in most countries require installation of new appliances and pipe work to be tested for approval. The most common procedure is for testing leakage at a test point with the use of a manometer, bourdon gauge or bubble leak detector kit. These devices for testing are removed after testing and the test point sealed after completion of testing by the gasfitter. No test device is left available for the consumer or others to identify a gas leak.

When a storage tank is empty or low it is either replaced with a full gaseous fuel container or is refilled on site. To do this, each container to be replaced or refilled must be disconnected from the pipe network. For properties with a single gaseous fuel container, disconnecting the container also cuts supply of the gaseous fuel to the appliances that are connected to the conveying means at this site. For safety reasons and availability to be replaced or refilled, the gas containers are located outside buildings.

For a gas appliance which is in use when the gas container supplying it with gaseous fuel is empty, the gas controller on this appliance remains open and the gaseous fuel would leak when a new or refilled gas container is connected to the conveying means. Leaking gas can cause gas poisoning to occupants and may cause explosion if an occupant attempts to light the appliance. In a LPG cylinder exchange system, the supplier has no way of identifying whether the consumer has left an appliance turned on, when exchanging a empty cylinder for a full cylinder.

The applicant has observed that efficiency of gas appliances at some sites tends to reduce overtime. Research has discovered that some of the gas containers are contaminated with impurities such as oil residues or waxy solids and the impurities will flow into the conveying means. In time, the flow passage in the conveying means will become partially clogged. The impurities can also block some openings in the jets of a connected appliance. In some geographical areas, contaminants in LP Gas form “oily residues” or “waxy solids” with auto refrigeration of vaporizing propane, or plasticiser residue from a LPG cylinder flexible hose (pigtail) lining, especially in association with fine particulates. Also, condensation and pipe scale in Natural Gas and LP Gas systems, can interfere with proper operation of safety lock-offs, overpressure vents, regulators and gas meters,

### OBJECTS OF THE INVENTION

An object of the present invention is to provide a monitoring device which alleviates or to reduces to a certain level one or more of the above prior art disadvantages.

### OUTLINE

In one aspect therefore, the present invention resides in a monitoring device for gaseous fuel. The device comprises a body formed with a reservoir covered with an observation window, an inflow passage extending from an inlet port into the reservoir, and an outflow passage extending from an outlet port to the reservoir. The inlet port is for connection to a gaseous fuel source and the outlet port is for connection to gas conveying means for supplying gaseous fuel from network or the container (s) to one or more gas appliances. The reservoir is partially filled with a mixture of a liquid which remains in liquid state in use and a surfactant capable of breaking down oily substance. The liquid mixture is filled to a level above the inner end of the inflow passage. One or more baffle members are provided in the reservoir at a position above the liquid mixture and the baffle member extends across the outflow passage.

Preferably, said gaseous fuel source is from a reticulated gaseous fuel network or from one or more gaseous fuel containers. The in use temperature range may be between at least from −15° to 50° Celsius.

When the gas appliance or one of the gas appliances connected to the conveying means is in use, the outlet pressure is less than the inlet pressure and the gaseous fuel passes through the liquid mixture to equalize pressure between the inlet and outlet and creates bubbles for the observation. The bubbles indicate that said gas appliance or said one of the gas appliances is in use, or a leak occurs in the conveying means.

It is preferred that the liquid in the mixture is ethylene glycol, and the surfactant is detergent. The mixture may also contain water, Ethylene Glycol will lower the freezing point of the mixture. For example, a 30% ethlylene glycol and 70% water mixture has a freezing point of −16 degrees Celsius. One example of the mixture is 67% ethylene glycol, 28% water and 5% detergent. Detergent molecules are attracted to both water and oil since one end of each detergent molecule attaches to a water molecule and the other end attaches to an oil molecule. Detergent is attracted to both oil and water because one end is hydrophilic (or ‘water-loving’) and sticks to water and the other end is hydrophobic and sticks to oil. Adding oil to detergent and water results in the liquids being attached to each other by the detergent molecules and form an emulsion.

The monitoring device may have one or more contaminant filter member provided in the reservoir, Preferably, the contaminant members) is positioned in a section of the reservoir above the liquid mixture level. The filter member(s) is for trapping contaminant materials in the gaseous fuel to be within the reservoir while allowing gaseous fuel pass therethrough. The filter member(s) may be formed of a cellulose ester membrane filter or zeolite filter, with or without a stainless steel mesh backing. The filter member(s) allows gaseous fuel to pass through and restricts any liquid from leaving the reservoir. The device is preferably positioned upstream of a gas regulator. Preferably, one or more baffles are provided in the reservoir and downstream to the filter member(s). When a LPG exchange cylinder is changed and turned on, the baffle member(s) in the reservoir prevent liquid from being forced against the filter member(s).

Desirably, the window is marked with a liquid level indicator which marks the top level for the liquid mixture in the reservoir.

While developing the invention, the inventor has observed that when the monitoring device is connected upstream of a gas regulator and a full 45 kg gas cylinder is connected to the regulator, a certain amount of the LP Gas in liquid form is transferred to the reservoir of the monitoring device. This phenomenon is unexpected as there is no such transfer when the device is connected to the downstream side of the regulator or to a reticulated natural gas network. in an experiment, a full LPG cylinder was connected to an empty LPG cylinder. After a period of 20 minutes at the ambient temperature of 20 degrees Celcius, the weight of the empty cylinder increased by 1.6 kg, being equivalent to 3.13 litres of liquid petroleum gas transferred from the full cylinder to the empty cylinder. It would thus appear that the monitor device is akin to an empty cylinder. But, further observations revel that in early morning the liquid form of the LPG does not appear in the reservoir of the device. These observations suggest that the LPG in the reservoir would transfer back to the cylinder when the temperature of the cylinder is lower than the temperature of the monitoring device. This effect is undesirable as it would cause an error interpretation of functioning of the monitoring device.

The applicant believes that LP gas condenses and reforms at different on ambient temperatures. To prevent this phenomenon from happening, the inventor conducted many experiments. To his surprise, he discovered that when a 350 kPa pressure limiting valve is installed on the inlet port of the monitoring device, this phenomenon did not occur. in one experiment, the vapour pressure is 355 KPa at −1 degrees Celsius.

Accordingly, it is further preferred that the device includes a pressure limiting valve positioned upstream of the reservoir and the pressure limiting valve is configured to limit pressure of the gaseous fuel from the reticulated network or the one or more gaseous fuel containers to a preset maximum to substantially minimise transfer of liquid form of the fuel or vapour reforming as a liquid state to the reservoir.

The inventor has also observed that when disconnecting a full or partially full cylinder or reticulated gas system from the gas monitoring device, a pressure drop on the inlet port side causes the liquid mixture in the reservoir to backflow to the cylinder That means more liquid mixture must be added to the reservoir after each disconnection.

Accordingly, it is desired that the device includes a non return valve configured to prevent backflow of the gaseous fuel or the mixture to the one or more gaseous fuel containers or reticulated gas system.

It is further desired that the one or more baffle members in the gas monitoring device are in the form of a sintered metal filter configured to also function as a pressure snubber for reducing pressure spikes when the one or more containers are first turned on. Pressure spikes can cause damage to regulators and other components in a LP gas system.

The sintered metal filter may also be configured to function as a flashback arrestor. Flashback is the condition of the flame propagating down the hoses of an oxy-fuel welding and cutting system, flame burns backwards into the hose, causing a popping or squealing noise. It can cause an explosion in the hose with the potential to injure or kill the operator.

The liquid mixture in the reservoir also works as a flame arrestor. Liquid flame arrestors are liquid barriers which work as a siphon where the liquid stops the deflagration and/or detonation from entering and extinguishes the flame.

The device may have a float arranged to be movable by the liquid mixture in the reservoir to a position to seal the outlet port. The float would thus prevent the liquid mixture in the reservoir from flowing out of the outlet port.

### BRIEF DESCRIPTION OF THE DRAWINGS

In order that the present improvements may be more readily understood and put into practical effect reference will now be made to the accompanying drawings which illustrate preferred embodiments of the invention and wherein:

FIG. 1 is a schematic front view of one embodiment of the monitoring device for gaseous fuel according to the present invention;

FIG. 2 shows the monitoring device as shown in FIG. 1 with foreign material in the reservoir;

FIG. 3 is a schematic disassembled cut-away view of the monitoring device as shown in FIG. 1;

FIG. 3A is a schematic assembled cut-away front view of another embodiment of the monitoring device for gaseous fuel according to the present invention;

FIG. 3B is a disassembled exploded part view of the monitoring device as shown in FIG. 3A

FIG. 4 is a schematic assembled cut-away front view of the monitoring device as shown in FIG. 1;

FIG. 5 is a schematic assembled cut-away front view of a third embodiment of the monitoring device for gaseous fuel with another configuration of the inlet and outlet pipes;

FIG. 6 is a schematic cut-away side view from the right hand side of the monitoring device as shown in FIG. 5;

FIG. 7 is a schematic cut-away side view from the left hand side of the monitoring device as shown in FIG. 5;

FIG. 8 is a schematic view of a LPG gas installation having a form of the monitoring device for gaseous fuel with a flow window installed;

FIG. 9 is a schematic view of a LPG gas installation having another form of the monitoring device for gaseous fuel and shows how the flow window installed;

FIG. 10 is a schematic view of a LPG gas exchange cylinder installation on a building;

FIG. 11 is a schematic view of a reticulated Natural gas installation on a building; and

FIG. 12 is a chart showing LPG vapour pressure at different temperatures.

### METHOD OF PERFORMANCE

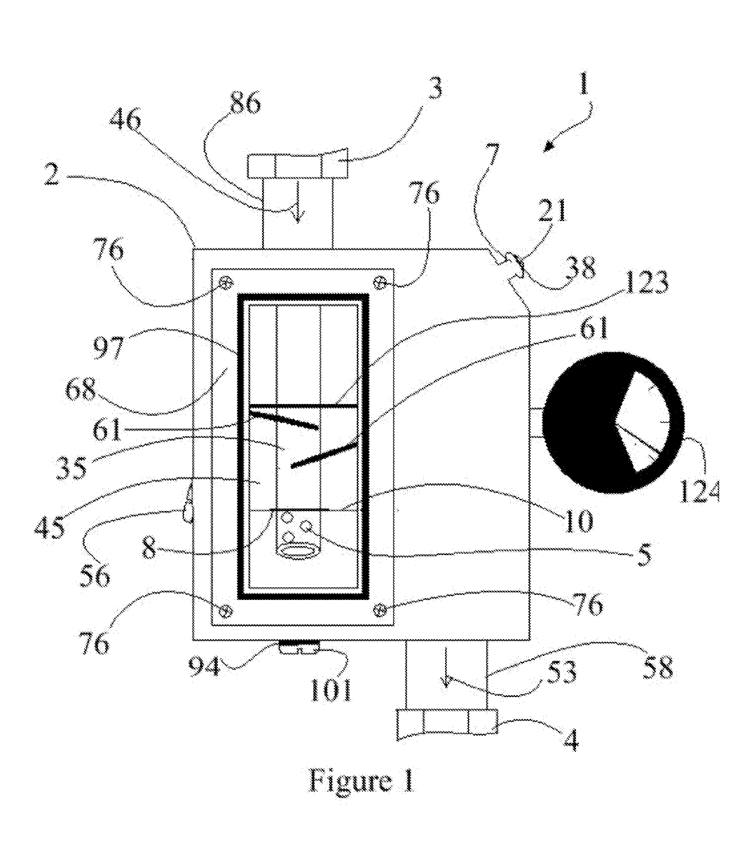

Referring to the drawings and initially to FIG. 1, there is shown a non limiting example of the monitoring device 1 for gaseous fuel according to the present invention. The device 1 has a body 2 which has been machined or forged to form the following configurations. The body is formed with a hollowed section configured as a reservoir 45 which is closed with a transparent or translucent material serving as a window 68. The window is fixed in position with screws 76. A gasket 97 is provided to seal the window 68 and the reservoir 45 holds liquid 10 which has been filled to a required level shown by a liquid level indicator 8. The reservoir is exposed for filling purposes by removing a filler plug 56. The liquid 10 in the reservoir 45 can be drained by removing a drain plug 101.

The device 1 in this example is installed in a LPG cylinder gas line serving as conveying means for the gaseous fuel. The device as shown has a gas inflow conduit or passage 86 with a gas inlet port 3, and a gas outflow conduit or passage 58 with a gas outlet port 4. The gas inflow passage 86 includes a delivery tube 35 which is partially submersed in the liquid 10. The arrow 46 indicates the direction of gas flow before passing through the liquid 10. Gas passing through the liquid 10 creates bubbles 5 providing a visual display of gas flow through window 68. Baffles 61 and filter gauze 123 prevents any liquid 10 from entering the outlet passage 58. An arrow 53 indicates the direction of gas flow after passing through the liquid 10. The device 1 has a test point 7 for testing leakage using any of the known methods. The test point 7 is closed with a screw 21 and sealed with a gasket 38. Unwanted foreign material from gaseous fuel source such as from the LPG cylinder or reticulated gas system is trapped in the reservoir 45 and can be drained by removing drain plug 101 which is sealed by gasket 94. The device 1 has a LPG vapour gauge 124 which allows the consumer or installer to know the pressure of gas in the LPG cylinder.

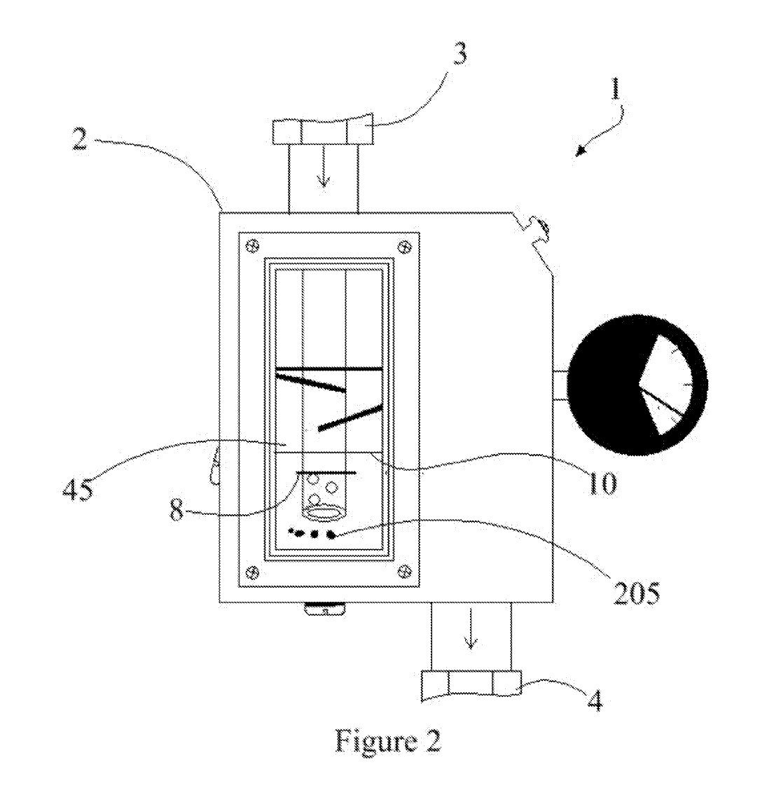

Referring now to FIG. 2, the device 1 as shown in FIG. 1 has been in use for a while and contaminants such as pipe scale or other foreign material 205 is trapped in the reservoir 45. Because of the presence of these contaminants liquid 10 in the reservoir 45 has risen above the liquid level indicator 8. The raised level provides a cue for the observer to check whether there are contaminants in the reservoir 45. It also allows the observer to readily identify pipe scale or oil being trapped in the reservoir 45.

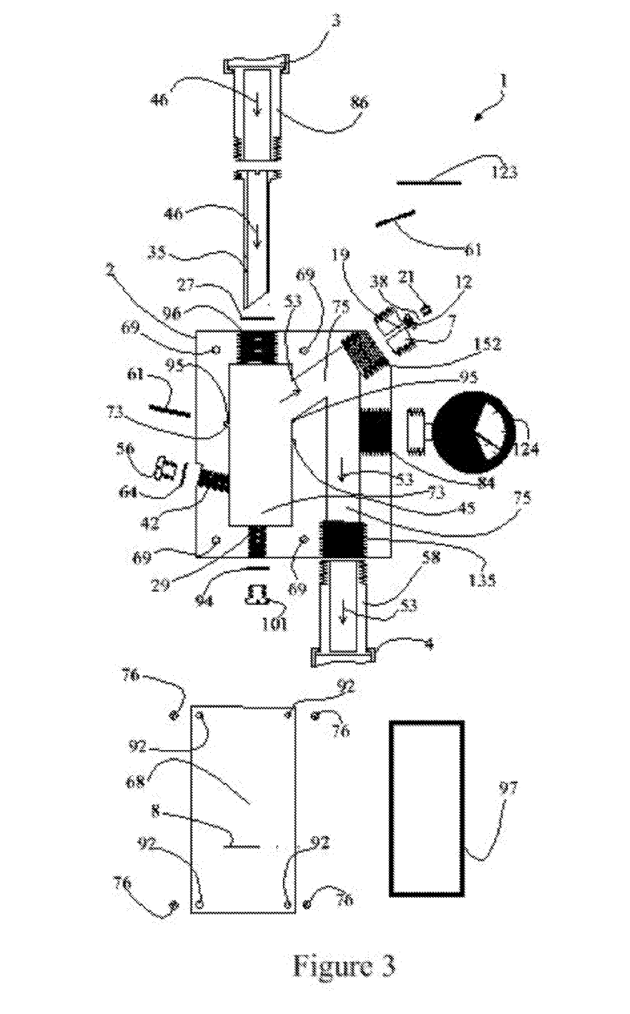

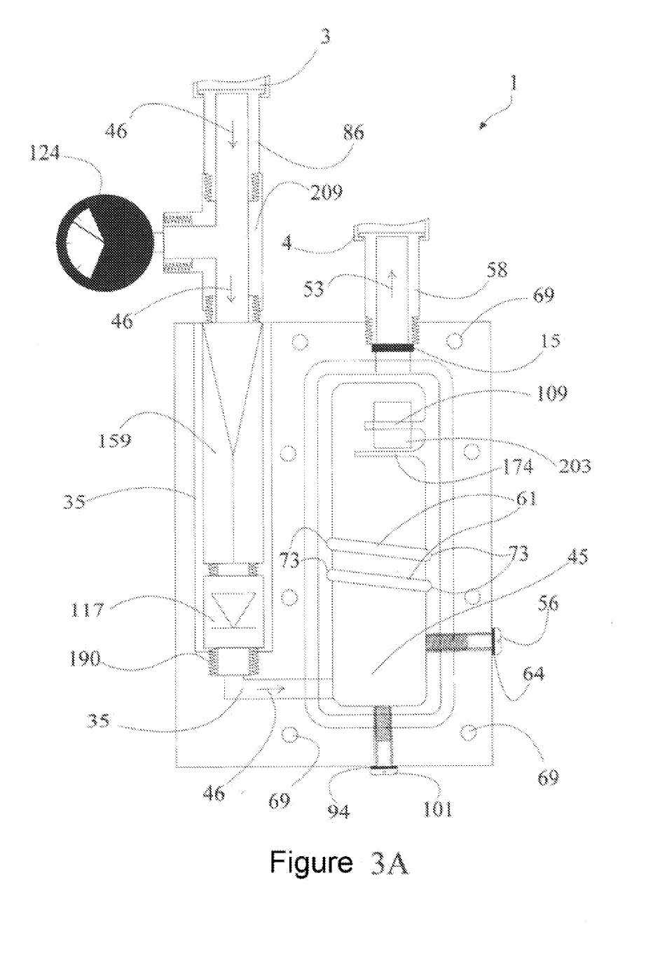

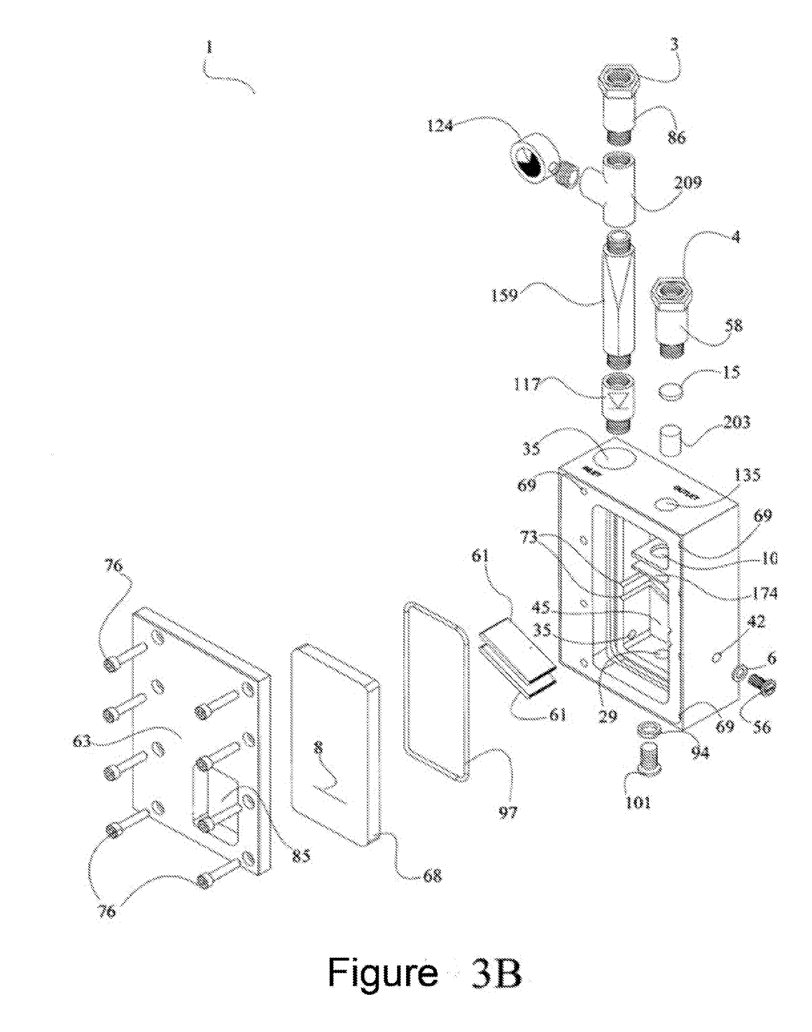

Referring now to FIG. 3, the embodiment of the device 1 as shown has its reservoir 45 in communication with a threaded passageway 96 and a passageway 75 with threaded sections 135, 152 and 84. Threaded passageway 96 is for receiving the delivery tube 35. The delivery tube 35 is to be sealed at the base of threaded passageway 96 with gasket 27. Threaded passageway 96 is arranged to receive gas inlet pipe 86 and threaded section 135 is for receiving a gas outlet pipe 58. Threaded section 152 is arranged to receive test plug 7 which has a passageway 19 to allow testing of a gas system using the normal procedure such as a manometer. Passageway 19 has a threaded section 12 which is for receiving a screw 21. Gasket 38 is used to seal test plug 7 after normal procedure testing of the gas system.

Baffles 61 is held in position by recessed sections 73 formed in walls surrounding the reservoir 45. The gauze 123 is held in position by recessed sections 95 formed in the reservoir 45 walls. Window 68 is a plate of transparent material with screw locating holes 92. A gasket 97 is provided for sealing the reservoir 45. The window 68 has a marker 8 to indicate the required fill level and is fixed into position with screws 76 through holes 92 into threaded locations 69 in the body 2. A threaded passageway 29 extending from the exterior of the device 1 to the reservoir 45 is provided for draining purposes. A drain plug 101 and a gasket 94 are provided for sealing threaded passageway 29. A threaded passageway 42 extending from the exterior of the device 1 to the reservoir 45 is provided for filling purposes and a filling plug 56 and gasket 64 are used to seal threaded passageway 42. The LPG vapour gauge 124 allows the consumer or fitter to know the gas pressure in the gas system,

Referring to FIG. 3A the embodiment of the device 1 as shown has its reservoir 45 in communication with a delivery tube 35. This device has a pressure limiting valve 159 connected in series with a non return valve 117 which is threadedly connected to the base of the delivery tube 35. A tee section 209 is threadedly connected to the pressure limiting valve 159. The tee section 209 is arranged to receive a pressure gauge 124 and an inlet pipe 86. Sintered metal filters 61 are held in place in the reservoir 45 by grooves 73 (see FIG. 3B). A platform 174 is arranged to support a movable float 203 held in position by portion 109. The float 203 would rise in the event the liquid level in the reservoir 45 is too high and would then move to a position to close outlet 75. Gas passes through the final filter 15 to the outlet pipe 58 connected by threaded portion 135 (see FIG. 3B).

Referring now to FIG. 3B, this embodiment of the device 1 has an o'ring sealing member 97, a front cover 63 with cutout section 85 for viewing through window 68 into reservoir 45. The front cover 63 has through holes for receiving fixing screws 76 which are to be threadably engaged with threaded holes 69 in the body of the device 1. When engaged, the front cover holds the window 68 in place against the sealing member 97.

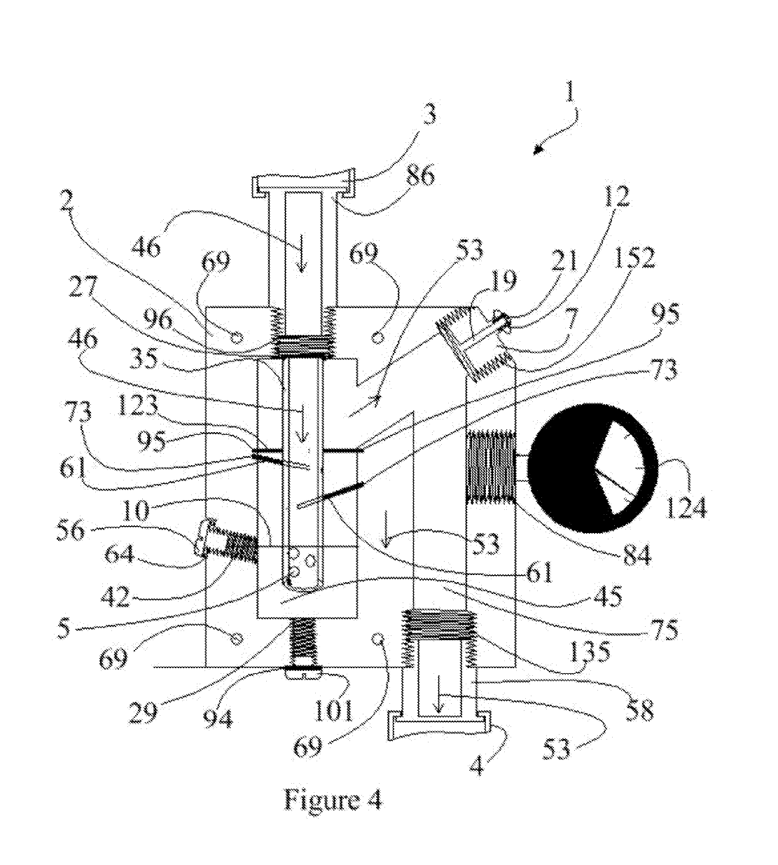

Referring to FIG. 4, this example of the device 1 as shown has its reservoir 45 in communication with a threaded passageway 96 and a passageway 75 configured with threaded sections 84, 135 and 152. Threaded passageway 96 is arranged to receive the inlet pipe 86 and delivery tube 35. The delivery tube 35 is sealed at the base of threaded passageway 96 with gasket 27 before gaseous fuel flows through the liquid 10. Arrows 46 indicate the direction of gas flow before passing through the liquid 10. A drop in pressure due to gas usage or leakage will create unequal pressures in the inlet pipe 86 and the outlet pipe 58 causing the gas to flow through the liquid 10 in the reservoir 45 and thereby creating bubbles 5. A baffle 61 can be bonded into recess 73 and a filter gauze 123 is held in position by recess 95. The baffle 61 and gauze 123 allow, gas to flow into, but prevent liquid 10 from entering passageway 75. This arrangement allows the gas to flow to the outlet pipe 58. Arrows 53 indicate the direction of gas flow after the gas has flown through the liquid 10. The reservoir 45 is filled to the required level with liquid 10 through the threaded passageway 42. The test plug 7 is threaded into threaded section 152. The test plug 7 has a passageway 19 with a threaded section 12 configured to receive screw 21 and gasket 38 is provided to seal the passageway 19 after normal procedure testing of the gas system. Unwanted foreign materials from LPG cylinder gas is trapped in the reservoir 45 and can be drained by removing drain plug 101 sealed by gasket 94 The LPG vapour gauge 124 will allow the consumer to know the gas pressure in the gas system.

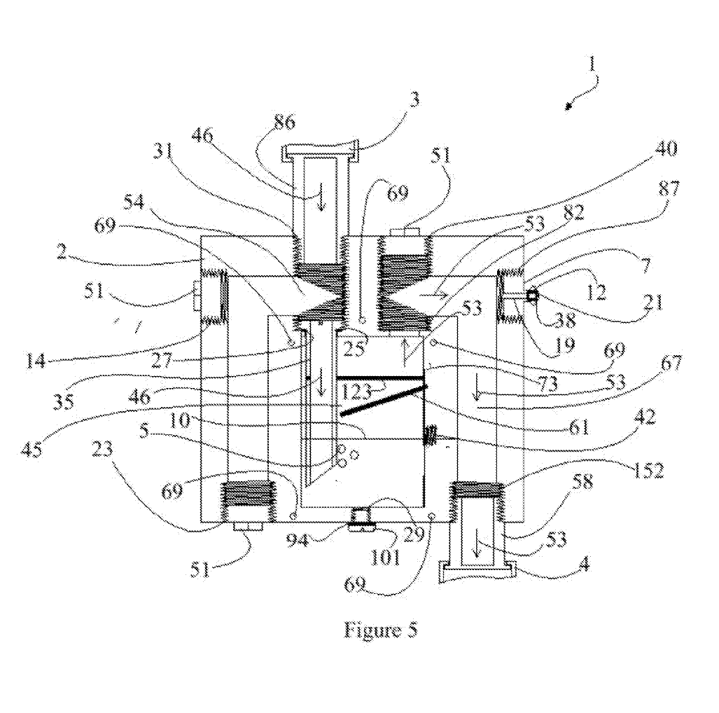

FIG. 5 shows another example of the device 1 for a reticulated gas system, This device has an inlet pipe 86 or passage threaded into threaded section 31 of passageway 54 and outlet pipe or passage 58 threaded into threaded section 152 of passageway 67. Arrows 46 indicate the direction of gas flow in passageway 54. The gas is directed to flow through the delivery tube 35 which is threaded into threaded section 25 and sealed by gasket 27, before the gas has flown through the liquid 10. A drop in pressure by gas usage or leakage will create unequal pressure in the inlet pipe 86 and outlet pipe 58 causing the gas to flow through the liquid 10 in the reservoir 45 and creating bubbles 5. A baffle 61 can be bonded into recess 73 and filter 123 pressed into position. The baffle 61 allows gas and prevent liquid 10 from being forced against filter 123. Filter 123 will further filter the gas and prevent any liquid 10 entering passageway 67 allowing the gas to flow to the outlet pipe 58. Arrows 53 indicate the direction of gas flow after the gas has flown through the liquid 10. The reservoir 45 is filled to the required level with liquid 10 through the threaded passageway 42. A test plug 7 is threaded into threaded section 87. The test plug 7 has a passageway 19 with a threaded section 12 configured to receive screw 21 and gasket 38 is provided for sealing the passageway 19 after normal procedure testing of the gas system. A drain plug 101 for draining the reservoir 45 is threaded into threaded passageway 29 which is sealed by gasket 94. Threaded holes 69 are provided to receive the window screws as shown in FIG. 6. Plugs 51 for sealing openings of passageways are not required in this example.

In FIG. 6, the device 1 as shown has an inlet pipe 86 which is threaded into threaded section 31. A transparent window 68 is fixed into position by screws 76 and sealed by gasket 97 to allow reservoir 45 to hold liquid 10 without leakage. Delivery tube 35 is sealed at the base of threaded section 25 by gasket 27. The end of delivery tube 35 is below the top level of the liquid 10 in the reservoir. Plugs 51 seal openings of passageway. Arrows 46 indicate the direction of gas flow before the gas has flowed through the liquid 10.

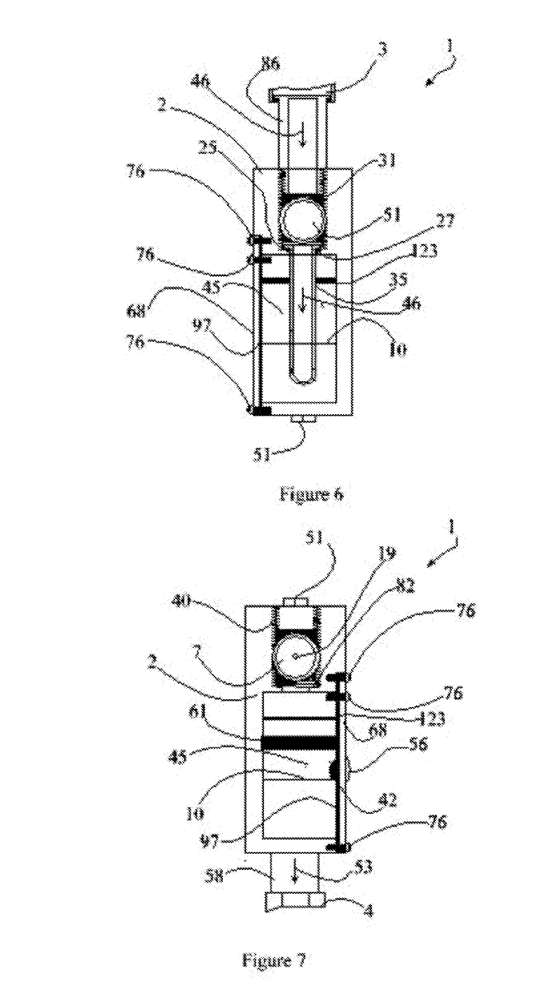

Referring now to FIG. 7, the device 1 as shown is installed to outlet pipe 58. A transparent window 68 is fixed into position by screws 76 and sealed by gasket 97 to allow reservoir 45 to hold liquid 10 without leakage. The reservoir 45 is filled to the required level with liquid 10 by through threaded passageway 42 after removing fill plug 56. Test plug 7 has a passageway 19 for normal testing procedure of the gas system. Plug 51 for sealing an opening of passageway. Arrow 53 indicates the direction of gas flow after the gas has flown through the liquid 10.

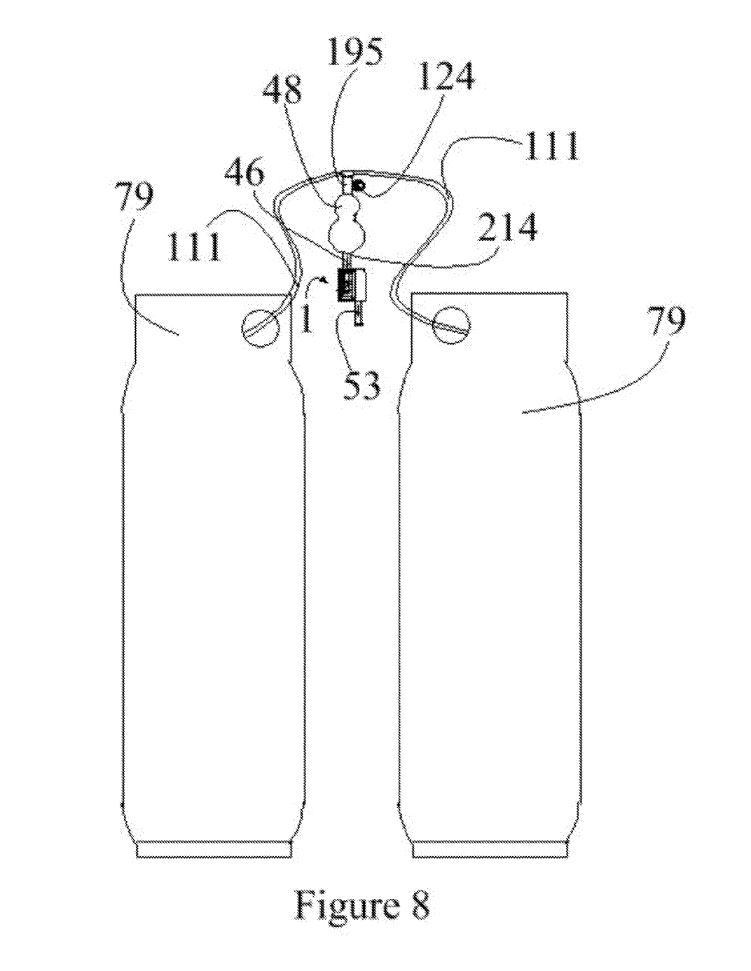

FIG. 8 shows a typical LPG gas system comprising of LPG gas cylinders 79, flexible connections 111 connected for supplying the LPG gas to the regulator 48 with outlet pipe 214. In this application, the device 1 as shown in FIG. 1 is installed after the regulator 48 with the exception that the gauge 124 is installed before the regulator 4 by a tee section 195. Arrow 46 indicates the direction of gas flow before entering the device 1 and arrow 53 indicates the direction of gas flow after passing through the device 1.

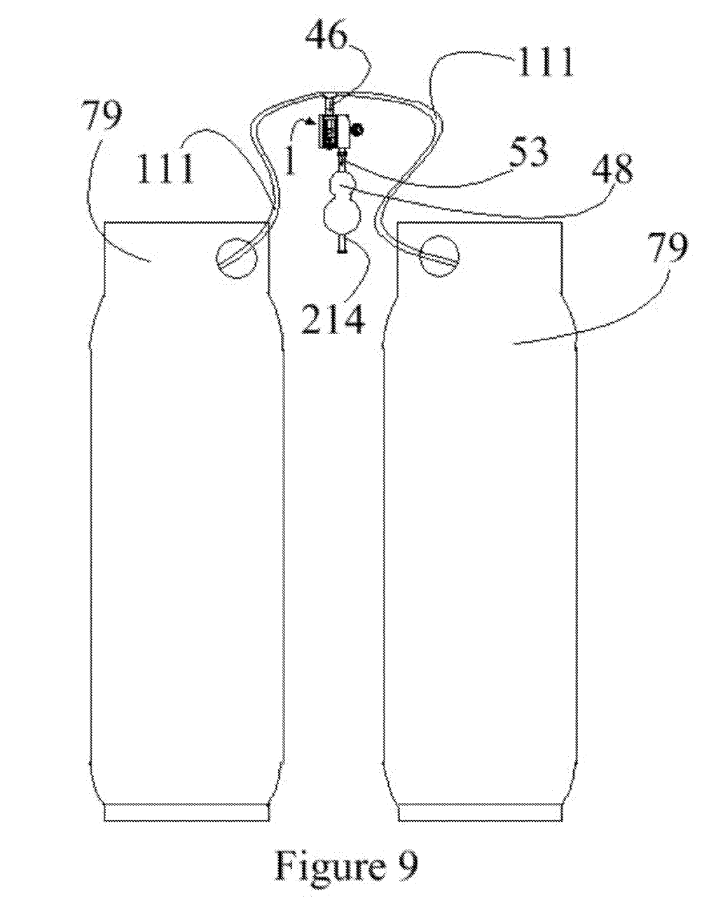

FIG. 9 shows typical LPG gas system comprising of LPG gas cylinders 79, flexible connections 111 connected for supplying the LPG gas to the regulator 48 with outlet pipe 214. In this application the device 1 as shown in FIG. 3A and FIG. 38 is installed before the regulator 48. Arrow 46 indicates the direction of gas flow before entering the device 1 and arrow 53 indicates the direction of gas flow after passing through the device 1. This installation of the device 1 traps unwanted foreign materials from LPG cylinder gas in the reservoir 45.

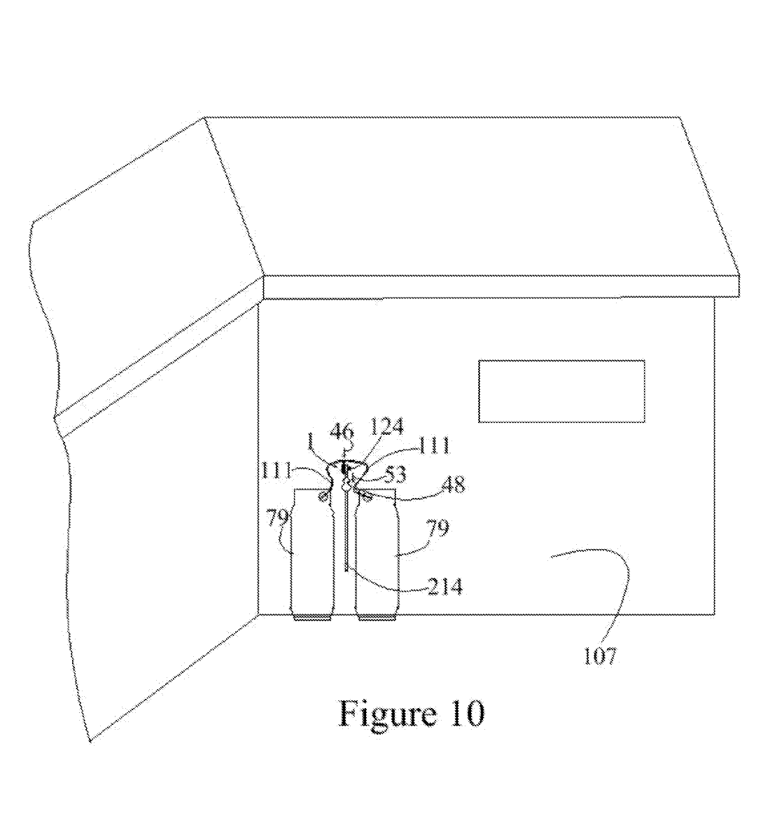

Referring now to FIG. 10, there is shown a typical LPG gas system installed on a building 107. The system comprises LPG cylinders 79, flexible connections 111 connected for supplying the LPG gas vapour to the device 1. A LPG vapour pressure gauge 124 is provided to indicate the gas pressure in the in the LPG cylinders 79. In this application the device 1 as shown in FIG. 3A and FIG. 3B is installed before the regulator 48. Arrow 46 indicates the direction of gas flow before entering the device 1 and arrow 53 indicates the direction of gas flow after passing through the device 1. This installation of the device 1 traps unwanted foreign materials from LPG cylinder and provides the gaseous fuel to the regulator 48 with outlet pipe 214 to supply gas to the building 107 as required.

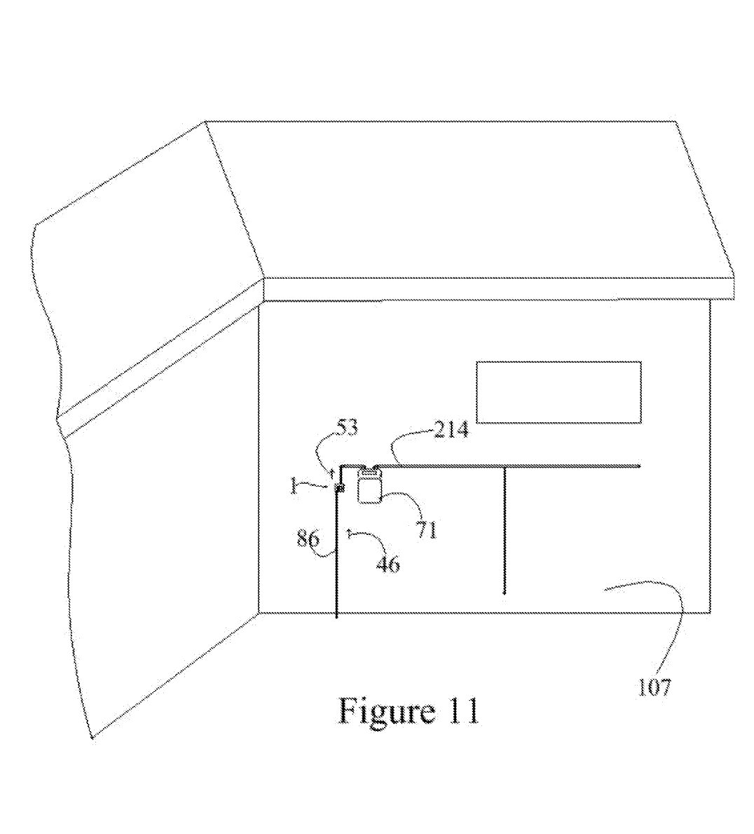

Referring now to FIG. 11, there is shown a typical reticulated gas system installed on a building 107. The system comprises of reticulated gas supply line 86 arranged to supply the reticulated gas to the device 1 as shown in FIG. 1. In this application the device 1 is installed before the gas meter 71. Arrow 46 indicates the direction of gas flow before entering the device 1 and arrow 53 indicates the direction of gas flaw after passing through the device 1. In this installation, the device 1 traps unwanted foreign materials from the reticulated gas supplying the gas meter 71 with outlet pipe 214 to supply gas to the building 107 as required.

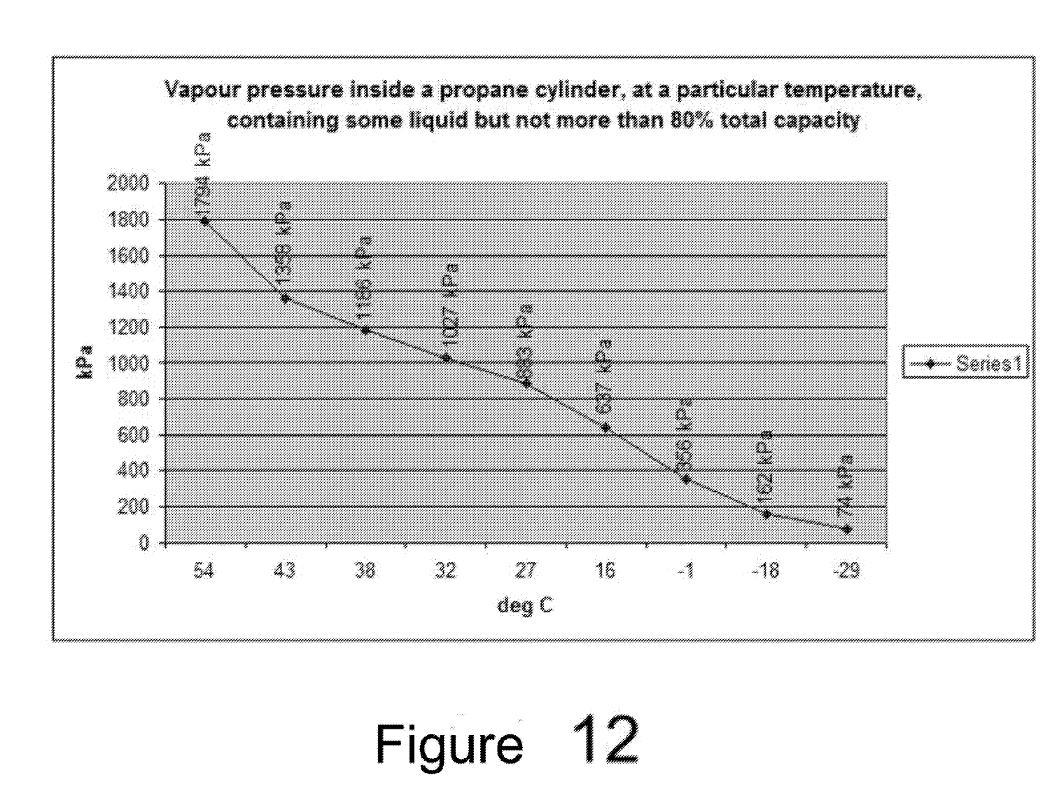

Referring now to FIG. 12, there is shown a chart of vapour pressure of a propane cylinder at a particular temperature, containing some Liquefied Petroleum Gas but not more than 80 percent of the propane cylinder total capacity. At an ambient temperature of 38 degrees Celsius, the vapour pressure is 1186 kPa and a lower vapour pressure of 883 kPa at an ambient temperature of 27 degrees Celsius. It was noted that the vapour pressure being the pressure of the LP gas vapour, reforms as a liquid state at a particular ambient temperature.

Whilst the above has been given by way of illustrative examples many variations and modifications will be apparent to those skilled in the art without departing from the broad ambit and scope of the invention as set forth in the following claims.

1. A monitoring device for gaseous fuel comprising a body formed with a reservoir covered with an observation window, an inflow passage extending from an inlet port into the reservoir, and an outflow passage extending from an outflow port to the reservoir, the inlet port being for connection to receive gaseous fuel and the outlet port being for connection to gas conveying means for supplying gaseous fuel from a reticulated gaseous fuel network or one or more gaseous fuel containers to one or more gas appliances, said reservoir being partially filled with a mixture of a liquid which remains in liquid state between at least from −5° to 50° Celsius and a surfactant capable of breaking down oily substance, the liquid mixture being filled to a liquid mixture level above the inner end of the inflow passage, one or more baffle members being provided in the reservoir at a position above the liquid mixture and the baffle member extends across the outflow passage.

2. (canceled)

3. The device according to claim 1 further including a gas volume monitor for monitoring volume of the gaseous fuel in the container(s).

4. The device according to claim 1 further including a gas volume monitor for monitoring volume of the gaseous fuel in the container(s) wherein the gas volume monitor has an ambient temperature compensation arrangement for compensating changes in pressure of the gaseous fuel from the container(s) due to ambient temperature changes.

5. The device according to claim 1, further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir.

6. The device according to claim 1, further including a non return valve configured to prevent backflow of the gaseous fuel or the mixture to the reticulated network or the said one or more gaseous fuel containers.

7. The device according to claim 1 wherein the one or more baffle members in the gas monitoring device are in the form of a sintered metal filter configured to also function as a pressure snubber for reducing pressure spikes when the reticulated network or the one or more containers are first turned on.

8. The device according to according to claim 1 wherein the liquid in the mixture is ethylene glycol, and the surfactant is detergent.

9. The device according to claim 1 wherein the liquid in the mixture is ethylene glycol and water, and the surfactant is detergent.

10. The device according to claim 1 wherein the mixture having 40% ethylene glycol and 60% water mixture and having a freezing point of −16 degrees Celsius.

11. The device according to claim 1 wherein the mixture having 67% ethylene glycol, 28% water and 5% detergent.

12. The device according to claim 1 further having one or more contaminant filter member(s) provided in the reservoir.

13. The device according to claim 1 further having one or more contaminant filter member(s) provided in the reservoir wherein the contaminant filter member(s) is positioned in a section of the reservoir above the liquid mixture level.

14. The device according to claim 1 further having one or more contaminant filter member(s) provided in the reservoir wherein the contaminant filter member(s) is formed of a cellulose ester membrane filter or zeolite filter, with or without a stainless steel mesh backing.

15. The device according to claim 1 further having a float arranged to be movable by the liquid mixture in the reservoir to a position to seal the outlet port.

16. The device according to claim 1 further including a gas volume monitor for monitoring volume of the gaseous fuel in the container(s), further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir, further including a non return valve configured to prevent backflow of the gaseous fuel or the mixture to the reticulated network or the said one or more gaseous fuel containers.

17. The device according to claim 1 further including a gas volume monitor for monitoring volume of the gaseous fuel in the container(s), further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir, further including a non return valve configured to prevent backflow of the gaseous fuel or the mixture to the reticulated network or the said one or more gaseous fuel containers, wherein the one or more baffle members in the gas monitoring device are in the form of a sintered metal filter configured to also function as a pressure snubber for reducing pressure spikes when the reticulated network or the one or more containers are first turned on.

18. The device according to claim 1 further including a gas volume monitor for monitoring volume of the gaseous fuel in the container(s), further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir, further including a non return valve configured to prevent backflow of the gaseous fuel or the mixture to the reticulated network or the said one or more gaseous fuel containers, further having one or more contaminant filter member(s) provided in the reservoir wherein the contaminant filter member(s) is positioned in a section of the reservoir above the liquid mixture level.

19. The device according to claim 1 further including a gas volume monitor for monitoring volume of the gaseous fuel in the container(s), further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir, further including a non return valve configured to prevent backflow of the gaseous fuel or the mixture to the reticulated network or the said one or more gaseous fuel containers, wherein the liquid in the mixture is ethylene glycol, and the surfactant is detergent.

20. The device according to claim 1 further including a gas volume monitor for monitoring volume of the gaseous fuel in the container(s), further including a pressure limiting valve positioned upstream of the reservoir and the pressure limiting valve is configured to limit pressure of the gaseous fuel from the said one or more gaseous fuel containers to a preset maximum to substantially minimise transfer of liquid form of the fuel to the reservoir, further including a non return valve configured to prevent backflow of the gaseous fuel or the mixture to the reticulated network or the said one or more gaseous fuel containers, wherein the liquid in the mixture is ethylene glycol and water, and the surfactant is detergent, the mixture having about 40% or about 67% ethylene glycol and about 28% or about 60% water respectively and having a freezing point of about −16 degrees Celsius.
